(19) United States
(12) Patent Application Publication
(10) Pub. No.: US 2017/0308652 A1
(43) Pub. Date: Oct. 26, 2017

(54) Systems and Methods of Reducing Healthcare Claims Denials

(71) Applicant: Robert Ligon, Duluth, GA (US)

(72) Inventor: Robert Ligon, Duluth, GA (US)

(21) Appl. No.: 15/492,479

(22) Filed: Apr. 20, 2017

Related U.S. Application Data
(60) Provisional application No. 62/325,687, filed on Apr. 21, 2016.

(51) Int. Cl. G06F 19/00

(52) U.S. Cl. CPC G06F 19/328

(57) ABSTRACT

Systems, methods, and computer-readable media are disclosed for reducing healthcare claims denials. Example methods may include generating a predictive model to determine a likelihood an insurance claim will be denied, receiving insurance claim data associated with an insurance claim, generating a denial score based at least in part on the insurance claim data, and generating a denial defeat recommendation based at least in part on the insurance claim data, the denial defeat recommendation comprising an action item. Certain embodiments may include presenting the denial score and the denial defeat recommendation, and determining that the action item has been completed.

### CROSS REFERENCE TO RELATED APPLICATIONS

This patent claims priority benefit of U.S. Provisional Application No. 62/325,687 filed Apr. 21, 2016, the contents of which are incorporated herein by reference in its entirety.

### BACKGROUND

Healthcare insurance claims may need certain information to be processed by an insurer. In some instances, insurance claims may be received by insurers without certain information, or with other deficiencies, and such insurance claims may be denied and/or underpaid by insurers. Insurance claims may be subject to coding standards that medical or administrative personnel are not familiar with, resulting in additional denied or underpaid claims due to incorrect coding. Many times, denied or underpaid insurance claims are incorrectly denied or underpaid, and are reversed after a healthcare provider or related entity appeals a denial or underpayment. For example, approximately 55-98% of denied claims may be overturned after appeal by a healthcare provider in certain instances.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic illustration of an example process flow for reducing healthcare claims denials in accordance with one or more example embodiments of the disclosure.

FIGS. 2-8 are schematic illustrations of example process flows for generating a propensity to deny score and for reducing healthcare claims denials in accordance with one or more example embodiments of the disclosure.

FIG. 9 is a schematic block diagram of an illustrative server device in accordance with one or more example embodiments of the disclosure.

### DETAILED DESCRIPTION

### Overview

This disclosure relates to, among other things, devices, systems, methods, computer-readable media, techniques, and methodologies for reducing healthcare claims denials. Certain embodiments may generate propensity to deny scores for one or more potential insurance claims. propensity to deny scores may be indicative of a likelihood that a particular insurance claim may be denied or underpaid. The propensity to deny scores generated by embodiments of the disclosure may be used to proactively address potential issues with insurance claims prior to submission, so as to increase a likelihood that the insurance claim will be approved and/or fully paid. For example, embodiments of the disclosure may analyze a healthcare provider organization's historical claim remittance data and the terms of their payer reimbursement contracts to determine potential procedural issues particular to the healthcare provider organization, and provide recommendations to resolve such issues to avoid or reduce future claims denials for the healthcare provider organization.

Embodiments of the disclosure may reduce an amount of denials and underpayments at point of patient presentation, rather than forcing healthcare provider businesses to address claims denials and underpayments after a patient may no longer be available. In some embodiments, conditions that lead to a payer denying all or part of a provider's claims for reimbursement may be identified. For example, conditions at the point of patient registration and during the patient's episode of care may be identified, and recommendations to reduce or eliminate such conditions may be generated. Certain embodiments may consider or otherwise assess the financial wherewithal of a patient to determine the patient's ability to pay personal liability. Embodiments of the disclosure may provide financial improvement benefit for healthcare providers by reducing rejection of claims in whole or in part.

Certain embodiments of the disclosure may generate one or more propensity to deny scores corresponding to one or more potential insurance claims. The propensity to deny scores may represent a likelihood that the particular claim will be denied and/or underpaid. Embodiments may generate recommendations to cure one or more defects in a potential insurance claim prior to submission, so as to reduce a likelihood that the claim will be denied or underpaid. A user interface may be generated notifying a user of the potential issues with an insurance claim, and may guide the user through one or more steps to cure the defects prior to submitting the insurance claim. For example, embodiments of the disclosure may determine whether correct coding standards (e.g., ICD-10 coding standards, etc.) are being used, and whether the payer or insurer has certain requirements that have not yet been satisfied. Using the propensity to deny scores and related recommendations, claims denials and underpayments may be reduced, thereby increasing revenue and efficiencies for healthcare provider organizations.

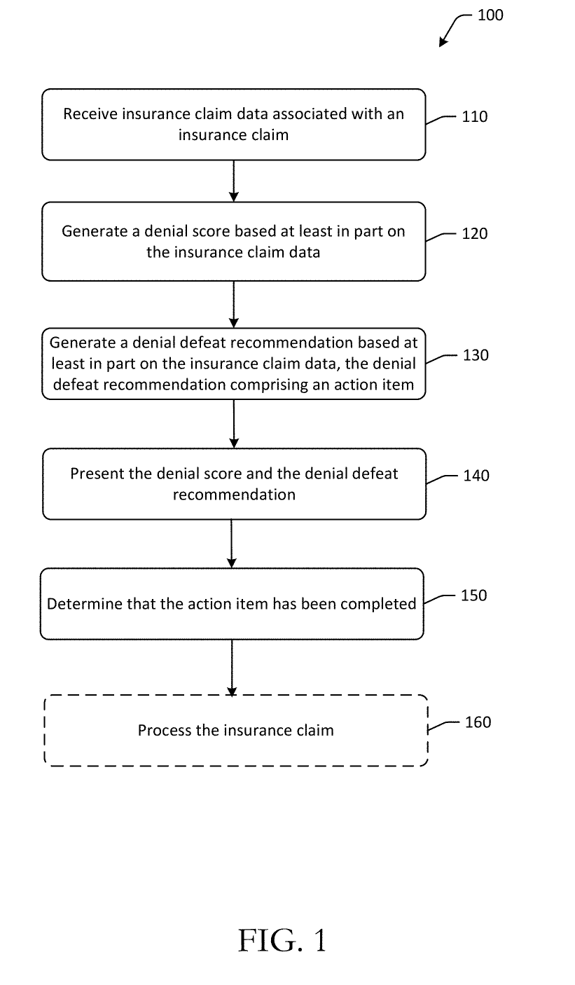

Referring to FIG. 1, an example process flow 100 for reducing healthcare claims denials is illustrated in accordance with one or more embodiments of the disclosure. At block 110 of the process flow 100, insurance claim data associated with an insurance claim is received. The insurance claim data may include patient information, payer information, such as a payer identifier, claim code information, expected payment amount, billed amount, and other data.

At block 120, a denial score is generated based at least in part on the insurance claim data. The denial score, also referred to herein as the propensity to deny score, may be indicative of a likelihood that the particular insurance claim will be denied. The denial score may be any suitable alphanumeric metric, graphical indicator, or other indicia configured to indicate the likelihood the claim will be denied. In some embodiments, a first denial score may be generated, where the first denial score is an initial denial score, and may be generated at the time of initial presentation. A second denial score, or a working denial score, may be generated during a patient's stay as additional information is collected or received. For example, an initial denial score of 9/10 may indicate the claim will likely be denied, but a second denial score, or a working score, of 1/10 may indicate that the claim will likely be accepted. The second denial score may be generated after a correct claim code is entered, for example, or a bill amount or patient information is received.

At block 130, a denial defeat recommendation is generated based at least in part on the insurance claim data, where the denial defeat recommendation includes an action item. For example, if the insurance claim is coded incorrectly, resulting in a relatively high denial score, a denial defeat recommendation of correcting the code may be generated.

At block 140, the denial score and the denial defeat recommendation may be presented. For example, the denial score may be presented to a user to alert the user to the potential that a claim may be rejected. The denial defeat recommendation and/or denial score may be communicated to a user through a user interface and the user may be notified upon completion of a recommended action item (e.g., a stoplight changing from red to green upon completion of an action item, etc.).

At block 150, a determination is made as to whether the action item has been completed. For example, if denial defeat recommendation is to enter certain patient information, the action item may be complete after the requested patient information has been entered.

At optional block 160, the insurance claim may be processed once the denial score meets or exceeds a predetermined threshold and/or the action item(s) provided in the denial defeat recommendation have been addressed.

Using the denial score and/or denial defeat recommendation, a user may be able to cure deficiencies in the claim prior to submitting the claim for reimbursement. The systems, methods, computer-readable media, techniques, and methodologies for reducing healthcare claims denials may reduce or avoid incorrect claims denials and underpayment by evaluating a potential insurance claim before submission for reimbursement.

Example embodiments of the disclosure provide a number of technical features or technical effects. For example, in accordance with example embodiments of the disclosure, insurance claims may be automatically evaluated for deficiencies prior to submission for reimbursement. The above examples of technical features and/or technical effects of example embodiments of the disclosure are merely illustrative and not exhaustive.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

### Illustrative Processes and Use Cases

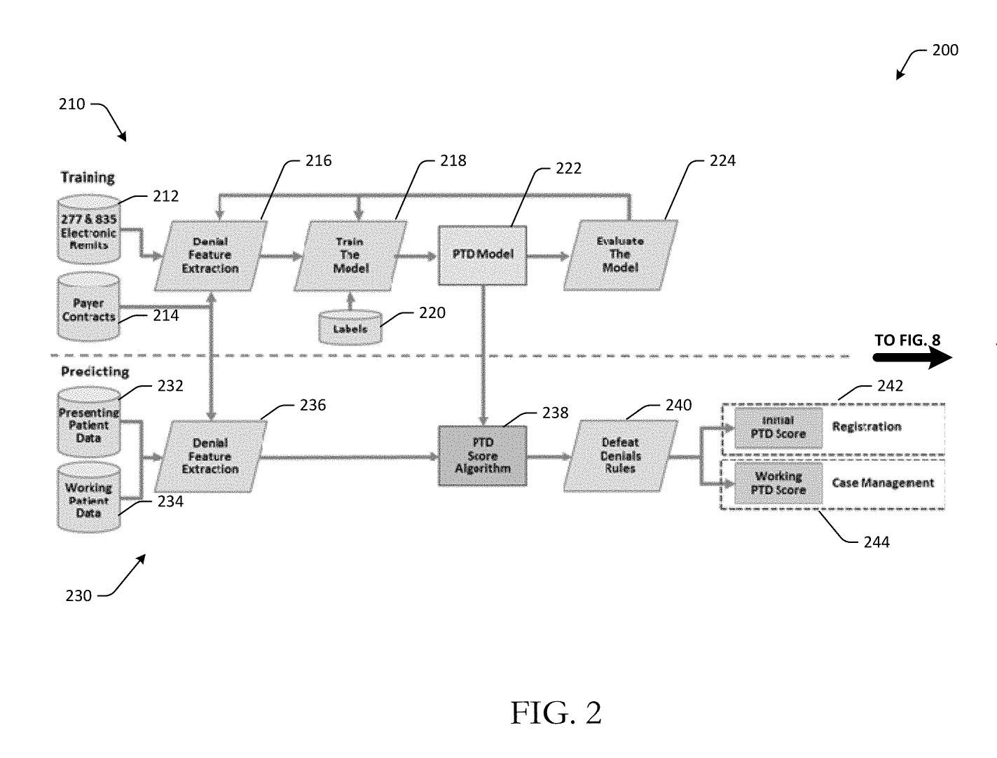

FIG. 2 depicts an process flow 200 for generating a propensity to deny score and for reducing healthcare claims denials in accordance with one or more embodiments of the disclosure. The process flow 200 includes a predictive model training portion 210 and a propensity to deny score generation portion 230.

The predictive model training portion 210 may be used to train a predictive model to accurately generate propensity to deny scores. The trained model may then be used to generate propensity to deny scores in the propensity to deny score generation portion 230 of the process flow 200.

Predictive models may be used for tasks that involve the prediction of one value using other values in a dataset. The learning algorithm attempts to discover and model the relationship between the feature being predicted and the other features. Because predictive models are prescriptive on what they need to learn and how they are intended to learn it, the process of training a predictive model is known as supervised learning. The supervision refers to the fact that the target values provide a way for the model to know how well it has learned the desired task. In other words, given a set of data, a supervised learning algorithm attempts to optimize the model to find the combination of features that result in the target output. The training process continues until the model achieves a desired level of accuracy on the training data. The often used supervised machine learning task of predicting which category an example belongs to is known as classification. In classification, the target feature to be predicted is a categorical feature known as the class, and is divided into categories called levels. A class can have two or more levels, and the levels may be rank ordered.

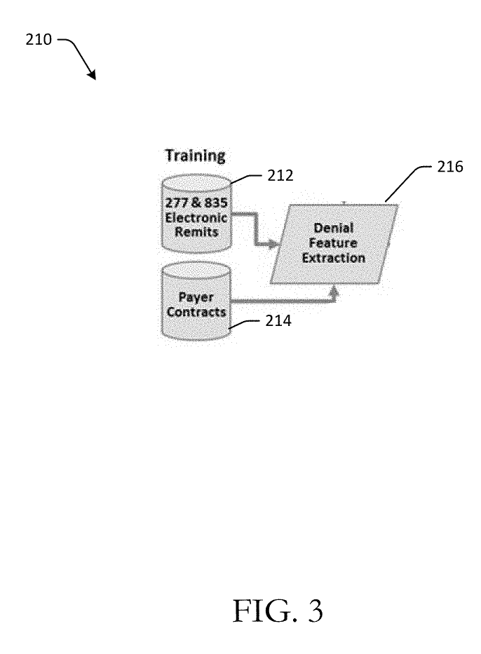

As shown in FIG. 3, the predictive model training portion 210 may include ANSI 277 and 835 data 212 sourced from a payer. The EDI 835 transaction set is called Health Care Claim Payment and Remittance Advice, and has been specified by HIPAA 5010 requirements for the electronic transmission of healthcare payment and benefit information. The 835 is used primarily by Healthcare insurance plans to make payments to healthcare providers, to provide Explanations of Benefits (EOBs), or both. When a healthcare service provider submits an 837 Health Care Claim, the insurance plan uses the 835 to detail the payment to that claim, including: (1) what charges were paid, reduced, or denied; (2) whether there was a deductible, co-insurance, co-pay, etc.; (3) any bundling or splitting of claims or line items; how the payment was made, such as through a clearinghouse; etc. A particular 835 document may not necessarily match up one-for-one with a specific 837 claim. In fact, it is not uncommon for multiple 835 transactions to be used in response to a single 837, or for one 835 to address multiple 837 submissions. As a result, the 835 is important to healthcare providers, to track what payments were received for services they provided and billed.

The EDI 277 Health Care Claim Status Response transaction set is used by healthcare payers (insurance companies, Medicare, etc.) to report on the status of claims 837 transactions) previously submitted by providers. The 277 transaction, which has been specified by HIPAA for the submission of claim status information, can be used in one of the following three ways: (1) a 277 transaction may be sent in response to a previously received EDI 276 Claim Status Inquiry; (2) a payer may use a 277 to request additional information about a submitted claim (without a 276); or (3) a payer may provide claim status information to a provider using the 277, without receiving a 276. Information provided in a 277 transaction generally indicates where the claim is in process, either as “pending” or “finalized.” If finalized, the transaction indicates the disposition of the claim—rejected, denied, approved for payment or paid. If the claim was approved or paid, payment information may also be provided in the 277, such as method, date, amount, etc. If the claim has been denied or rejected, the transaction may include an explanation, such as if the patient is not eligible. At implementation, the system is back loaded with a year's historical 277 and 835 data.

For initial data loading of the predictive model training portion 210, a certain amount (e.g., one year, etc.) of a provider's historical 277 and 835 data is loaded. Additionally, where possible, data feeds from the provider's payer contract database 214 are established. Relevant payer contract terms are loaded into a Denial Feature Extraction database 216.

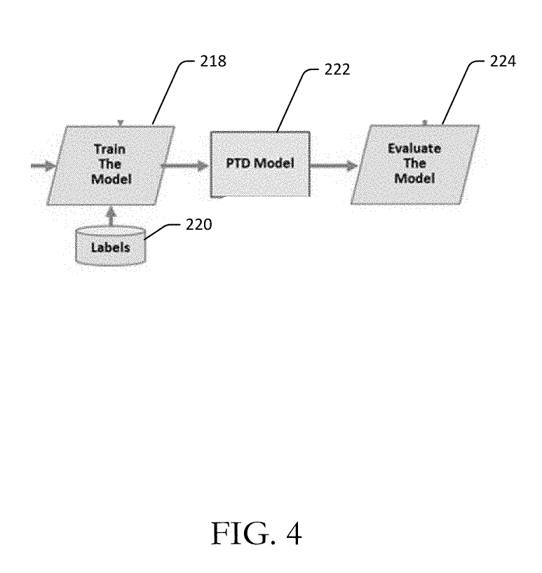

As shown in FIG. 4, upon loading the initial data, a propensity to deny model is developed. In some embodiments, a data mining modeler may be used or implemented to understand underlying relationships in observed data to train the predictive model.

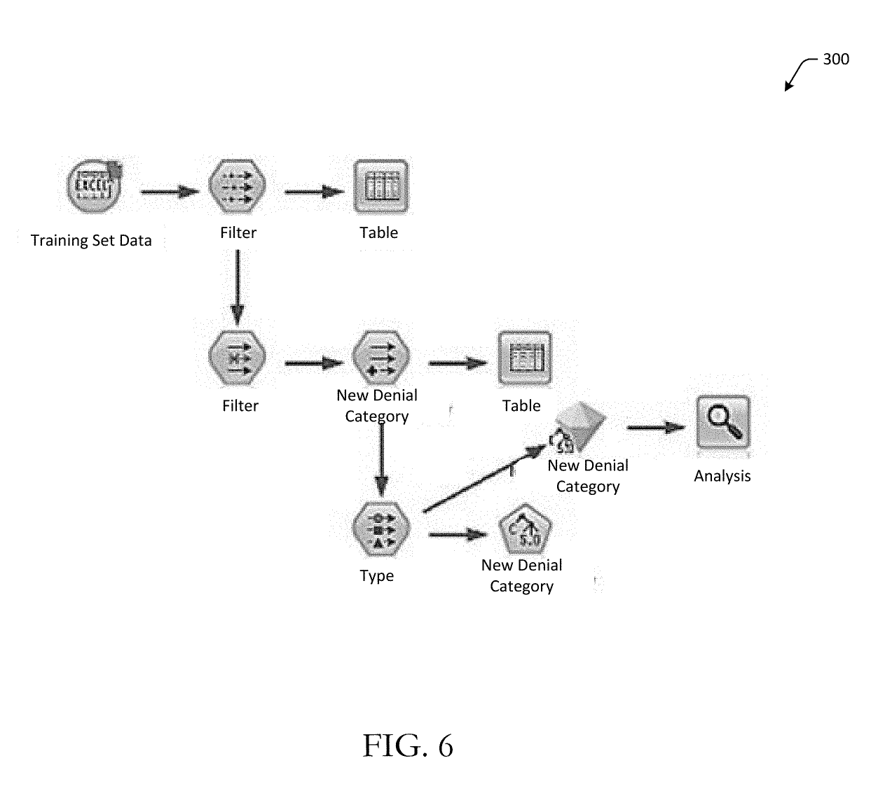

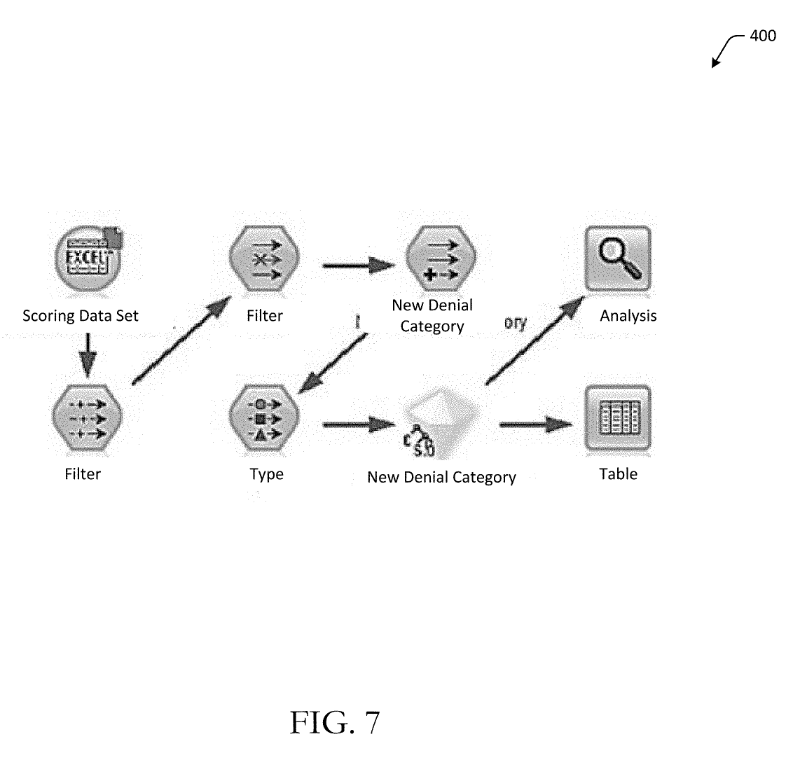

To develop the propensity to deny model, first the data is understood in order to determine which fields in the data to use as predictors and which ones to discard. In some embodiments, historical 835 remittance data may be used, while account payer contract terms enrichment is not used. Rather, payer contract terms may be used to enhance the accuracy of a propensity to deny score. Processing of the data may be used to determine which fields should be used as indicators. For example, rejection codes may be provided after a claim has already been rejected, and therefore may not be relevant to determining whether a claim will be rejected before submission. Example process flows for developing propensity to deny models and training predictive models are illustrated in process flow 300 of FIG. 6 and process flow 400 of FIG. 7.

The original data file may be partitioned in order to create a training data set and a scoring data set used to evaluate the model. The original data file may be portioned, for example, by an SPSS modeler. The training data set may be used to train the model at block 218. The model may also be trained using labels 220 that apply to one or more segments of the data.

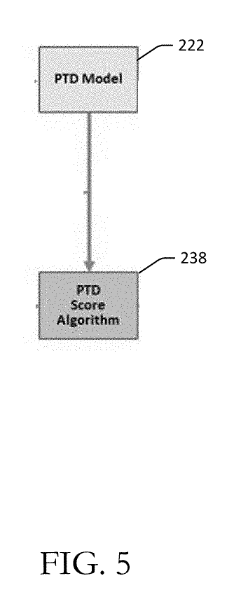

The model may be generated at block 222 and may include a number of relevant fields or factors for consideration. The model may be scored or evaluated at block 224 using the scoring data set. As shown in FIG. 5, the propensity to deny model may be used in determining a propensity to deny score algorithm 238, as discussed below.

Using the model, and in certain embodiments an additional algorithm, a propensity to deny score may be generated at the propensity to deny score generation portion 230 of the process flow 200. The propensity to deny score may be based at least in part on presenting patient data 232 and working patient data 234. Denial feature extraction may be performed at block 236, at which potential fields with values indicating that the claim may be rejected may be extracted from the data. In some embodiments, relevant payer contract terms may be loaded into the denial feature extraction 236.

At block 238, one or more algorithms may be applied to the data to generate a propensity to deny score. The propensity to deny score algorithm may feed into a defeat denials rules engine 240, which may be used to determine an initial propensity to deny score 242 (e.g., at patient registration) and a working propensity to deny score 244 (e.g., during case management). In some embodiments, the propensity to deny model 222 may be used in determining the propensity to deny scoring algorithm.

One or more denial threats may be identified and reflected in the propensity to deny score. For example, the propensity to deny score may be a composite of all line item detail threats, each with an individual score or subscore that factors into the overall propensity to deny score. The propensity to deny score may be derived by applying quantitative forecasting methodologies to the predictive model data. Quantitative forecasting is a statistical technique for making projections about the future which uses numerical facts and prior experience to predict upcoming events. The two main types of quantitative forecasting used by business analysts are the explanatory method that attempts to correlate two or more variables and the time series method that uses past trends to make forecasts.

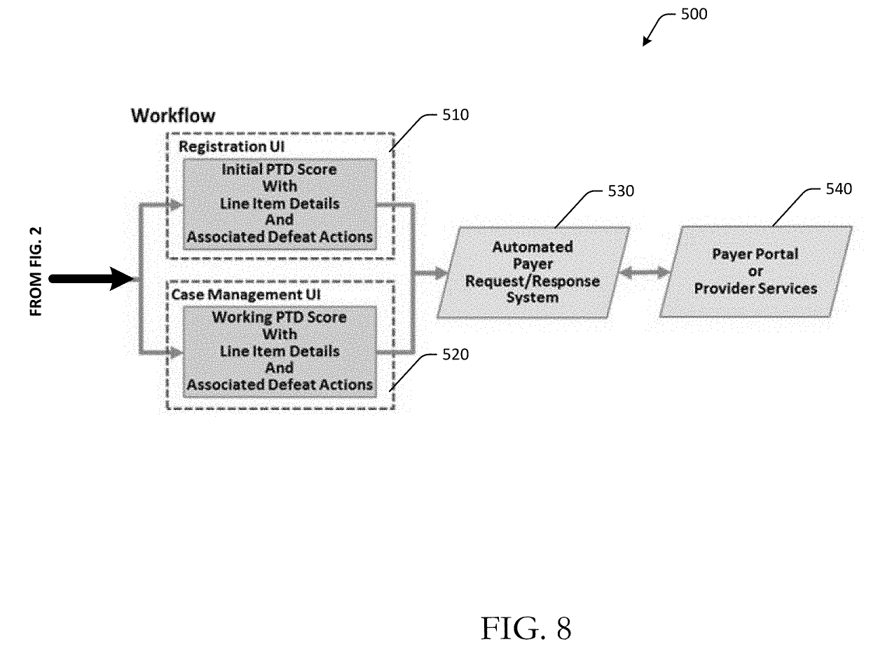

Referring to FIG. 8, a process flow 500 may receive the output of the process flow 200 of FIG. 2. An initial propensity to deny score with line item details (indicating potential deficiencies in the claim) and associated defeat actions (to overcome respective deficiencies) may be generated at registration 510, while a working propensity to deny score with updated line item details and corresponding defeat actions may be generated during case management 520.

The initial or working propensity to deny scores and related line item details may be matched to denials defeat rules. Denials defeat rules are actions that the user can take to eliminate the potential denial. For example, if the propensity to deny score is, in part, based on a failure to receive a medical necessity authorization, the denials defeat rules will direct the user to make sure that a medical necessity authorization is in place or, if not, it will direct the registrar to contact the payer to gain authorization. In some embodiments, denials defeat rules may be based, at least in part, on historical claims denial appeal cures. Such historical data may be collected by the system over time.

This information may be presented to the user through a user interface. The user may be directed to take action to eliminate each line item denial threat. The system may keep track of the user's actions to eliminate all threats through a “stop light” graphical indicator method that changes a threat from red to green once the user has completed a call to action.

Upon completion of the action items, the system may engage an automated payer request/response system at block 530 and payer portal or provider services at block 540. Further, the system will automate threat elimination call to action processes using autodialing, payer portal screen scraping and natural language technology, thus reducing manual intervention and account “touches.” Using web service calls, embodiments of the disclosure can be embedded into patient registration, case management and electronic medical record user interfaces.

Embodiments of the disclosure may provide a solution that alerts patient registrars, case managers, nurse auditors, and health information management to the potential for a presenting and in-house patient account to be denied in whole or part for reimbursement. Alerts may be at least partially in the form of the propensity to deny score. The alerts and threat resolution process will be implemented through a computer-based business rules driven workflow process.

One or more operations of the method, process flows, or use cases of FIGS. 1-8 may have been described above as being performed by a user device, or more specifically, by one or more program module(s), applications, or the like executing on a device. It should be appreciated, however, that any of the operations of methods, process flows, or use cases of FIGS. 1-8 may be performed, at least in part, in a distributed manner by one or more other devices, or more specifically, by one or more program module(s), applications, or the like executing on such devices. In addition, it should be appreciated that processing performed in response to execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-8 may be described in the context of the illustrative devices, it should be appreciated that such operations may be implemented in connection with numerous other device configurations.

The operations described and depicted in the illustrative methods, process flows, and use cases of FIGS. 1-8 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-8 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

### Illustrative Device Architecture

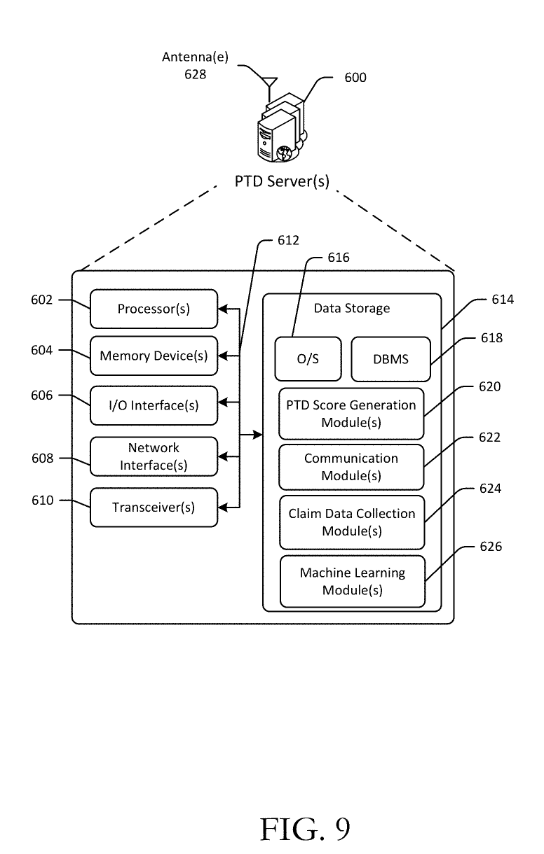

FIG. 9 is a schematic block diagram of an example propensity to deny server 600 in accordance with one or more example embodiments of the disclosure. The propensity to deny server 600 may include any suitable computing device capable of receiving and/or generating audio including, but not limited to, a mobile device such as a smartphone, tablet, e-reader, wearable device, or the like; a desktop computer; a laptop computer; a content streaming device; a set-top box; or the like. The propensity to deny server 600 may correspond to an illustrative device configuration for the server devices of FIGS. 1-8.

The propensity to deny server 600 may be configured to communicate via one or more networks with one or more servers, user devices, or the like. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the propensity to deny server 600 may include one or more processors (processor(s)) 602, one or more memory devices 604 (generically referred to herein as memory 604), one or more input/output (“I/O”) interface(s) 606, one or more network interface(s) 608, one or more transceivers 612, and data storage 614. The propensity to deny server 600 may further include one or more buses 612 that functionally couple various components of the propensity to deny server 600. The propensity to deny server 600 may further include one or more antenna(e) 628 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The data storage 614 may include removable storage and/or non-removable storage including, but not limited to, magnetic storage, optical disk storage, and/or tape storage. The data storage 614 may provide non-volatile storage of computer-executable instructions and other data. The memory 604 and the data storage 614, removable and/or non-removable, are examples of computer-readable storage media (CRSM) as that term is used herein.

The data storage 614 may store computer-executable code, instructions, or the like that may be loadable into the memory 604 and executable by the processor(s) 602 to cause the processor(s) 602 to perform or initiate various operations. The data storage 614 may additionally store data that may be copied to memory 604 for use by the processor(s) 602 during the execution of the computer-executable instructions. Moreover, output data generated as a result of execution of the computer-executable instructions by the processor(s) 602 may be stored initially in memory 604, and may ultimately be copied to data storage 614 for non-volatile storage.

More specifically, the data storage 614 may store one or more operating systems (O/S) 616; one or more database management systems (DBMS) 618; and one or more program module(s), applications, engines, computer-executable code, scripts, or the like such as, for example, one or more propensity to deny score generation module(s) 620, one or more communication module(s) 622, one or more claim data collection module(s) 624, and/or one or more machine learning module(s) 626. Some or all of these module(s) may be sub-module(s). Any of the components depicted as being stored in data storage 614 may include any combination of software, firmware, and/or hardware. The software and/or firmware may include computer-executable code, instructions, or the like that may be loaded into the memory 604 for execution by one or more of the processor(s) 602. Any of the components depicted as being stored in data storage 614 may support functionality described in reference to correspondingly named components earlier in this disclosure.

The processor(s) 602 may be configured to access the memory 604 and execute computer-executable instructions loaded therein. For example, the processor(s) 602 may be configured to execute computer-executable instructions of the various program module(s), applications, engines, or the like of the propensity to deny server 600 to cause or facilitate various operations to be performed in accordance with one or more embodiments of the disclosure. The processor(s) 602 may include any suitable processing unit capable of accepting data as input, processing the input data in accordance with stored computer-executable instructions, and generating output data. The processor(s) 602 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 602 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 602 may be capable of supporting any of a variety of instruction sets.

Referring now to functionality supported by the various program module(s) depicted in FIG. 9, the propensity to deny score generation module(s) 620 may include computer-executable instructions, code, or the like that responsive to execution by one or more of the processor(s) 602 may perform functions including, but not limited to, processing and/or analyzing insurance claim data, claim parameters, entered or stored values, and other data, generating propensity to deny scores for particular insurance claims or potential insurance claims, and other functions.

The communication module(s) 622 may include computer-executable instructions, code, or the like that responsive to execution by one or more of the processor(s) 602 may perform functions including, but not limited to, communicating with one or more devices, for example, via wired or wireless communication.

The claim data collection module(s) 624 may include computer-executable instructions, code, or the like that responsive to execution by one or more of the processor(s) 602 may perform functions including, but not limited to, receive and/or retrieve insurance claim data or inputs, patient information, insurance company data or claim requirements, and other functions.

The machine learning module(s) 626 may include computer-executable instructions, code, or the like that responsive to execution by one or more of the processor(s) 602 may perform functions including, but not limited to, generating or updating predictive models or other machine learning algorithms used to determine propensity to deny scores, and other operations.

Referring now to other illustrative components depicted as being stored in the data storage 614, the O/S 616 may be loaded from the data storage 614 into the memory 604 and may provide an interface between other application software executing on the propensity to deny server 600 and hardware resources of the propensity to deny server 600. More specifically, the O/S 616 may include a set of computer-executable instructions for managing hardware resources of the propensity to deny server 600 and for providing common services to other application programs (e.g., managing memory allocation among various application programs). In certain example embodiments, the O/S 616 may control execution of the other program module(s) to dynamically enhance characters for content rendering. The O/S 616 may include any operating system now known or which may be developed in the future including, but not limited to, any server operating system, any mainframe operating system, or any other proprietary or non-proprietary operating system.

The DBMS 618 may be loaded into the memory 604 and may support functionality for accessing, retrieving, storing, and/or manipulating data stored in the memory 604 and/or data stored in the data storage 614. The DBMS 618 may use any of a variety of database models (e.g., relational model, object model, etc.) and may support any of a variety of query languages. The DBMS 618 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the propensity to deny server 600 is a mobile device, the DBMS 618 may be any suitable light-weight DBMS optimized for performance on a mobile device.

It should be appreciated that the program module(s), applications, computer-executable instructions, code, or the like depicted in FIG. 9 as being stored in the data storage 614 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the propensity to deny server 600, and/or hosted on other computing device(s) accessible via one or more networks, may be provided to support functionality provided by the program module(s), applications, or computer-executable code depicted in FIG. 9 and/or additional or alternate functionality. Further, functionality may be modularized differently such that processing described as being supported collectively by the collection of program module(s) depicted in FIG. 9 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 9 may be implemented, at least partially, in hardware and/or firmware across any number of devices.

It should further be appreciated that the propensity to deny server 600 may include alternate and/or additional hardware, software, or firmware components beyond those described or depicted without departing from the scope of the disclosure. More particularly, it should be appreciated that software, firmware, or hardware components depicted as forming part of the propensity to deny server 600 are merely illustrative and that some components may not be present or additional components may be provided in various embodiments. While various illustrative program module(s) have been depicted and described as software module(s) stored in data storage 614, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

One or more operations of the methods, process flows, and use cases of FIGS. 1-9 may be performed by a device having the illustrative configuration depicted in FIG. 9, or more specifically, by one or more engines, program module(s), applications, or the like executable on such a device. It should be appreciated, however, that such operations may be implemented in connection with numerous other device configurations.

The operations described and depicted in the illustrative methods and process flows of FIGS. 1-9 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-9 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method comprising:
generating, by one or more computer processors coupled to at least one memory, a predictive model to determine a likelihood an insurance claim will be denied;
receiving insurance claim data associated with an insurance claim;
generating a denial score based at least in part on the insurance claim data;
generating a denial defeat recommendation based at least in part on the insurance claim data, the denial defeat recommendation comprising an action item;
presenting the denial score and the denial defeat recommendation; and
determining that the action item has been completed.

2. The method of claim 1, further comprising processing the insurance claim.

3. The method of claim 1, further comprising presenting the denial score at a user device.

4. The method of claim 1, further comprising:
determining an initial propensity to deny score;
determining a working propensity to deny score; and
using the initial propensity to deny score and the working propensity to deny score to generate the denial score.

5. The method of claim 1, further comprising identifying one or more denial threats based at least in part on the insurance claim data.

6. The method of claim 1, further comprising determining one or more line item details associated with the denial score.

7. The method of claim 6, further comprising determining the action item based at least in part on the one or more line item details.

8. The method of claim 1, wherein the action item is determined based at least in part on historical claims denial appeal data.

9. The method of claim 1, further comprising providing digital access to the denial defeat recommendation to a doctor, a patient, and a medical provider.

10. The method of claim 1, wherein determining that the action item has been completed comprises automatically determining that the action item has been completed.

11. A server comprising:
at least one memory that stores computer-executable instructions;
at least one processor configured to access the at least one memory and execute the computer-executable instructions to:
generate a predictive model to determine a likelihood an insurance claim will be denied;
receive insurance claim data associated with an insurance claim;
generate a denial score based at least in part on the insurance claim data;
generate a denial defeat recommendation based at least in part on the insurance claim data, the denial defeat recommendation comprising an action item;
present the denial score and the denial defeat recommendation; and
determine that the action item has been completed.

12. The server of claim 11, wherein the at least one processor is further configured to access the at least one memory and execute the computer-executable instructions to:
process the insurance claim.

13. The server of claim 11, wherein the at least one processor is further configured to access the at least one memory and execute the computer-executable instructions to:
present the denial score at a user device.

14. The server of claim 11, wherein the at least one processor is further configured to access the at least one memory and execute the computer-executable instructions to:
determine an initial propensity to deny score;
determine a working propensity to deny score; and
use the initial propensity to deny score and the working propensity to deny score to generate the denial score.

15. The server of claim 11, wherein the at least one processor is further configured to access the at least one memory and execute the computer-executable instructions to:
identify one or more denial threats based at least in part on the insurance claim data.

16. The server of claim 11, wherein the at least one processor is further configured to access the at least one memory and execute the computer-executable instructions to:
determine one or more line item details associated with the denial score.

17. The server of claim 16, wherein the at least one processor is further configured to access the at least one memory and execute the computer-executable instructions to:
determine the action item based at least in part on the one or more line item details.

18. The server of claim 11, wherein the action item is determined based at least in part on historical claims denial appeal data.

19. The server of claim 11, wherein the at least one processor is further configured to access the at least one memory and execute the computer-executable instructions to:
provide digital access to the denial defeat recommendation to a doctor, a patient, and a medical provider.

20. The server of claim 11, wherein the at least one processor is configured to access the at least one memory and execute the computer-executable instructions to determine that the action item has been completed by executing the computer-executable instructions to automatically determine that the action item has been completed.
